(19) United States
(12) Patent Application Publication
(10) Pub. No.: US 2022/0114608 A1
(43) Pub. Date: Apr. 14, 2022

(54) Automatic Generation of Individual Item Listings from a Bulk Listing

(71) Applicant: eBay Inc., San Jose, CA (US)

(72) Inventors: Saravanakumar Ganesan, San Jose, CA (US); Jing Zhao, Cupertino, CA (US); Anindita Banerjee, Cupertino, CA (US); Somashish Gupta, Fremont, CA (US); Alpha Kamchiu Luk, San Jose, CA (US)

(73) Assignee: eBay Inc., San Jose, CA (US)

(21) Appl. No.: 17/069,825

(22) Filed: Oct. 13, 2020

(51) Int. Cl. G06Q 30/02; G06Q 30/00; G06Q 30/06; G06Q 10/04; G06Q 10/06; G06N 5/04; G06N 20/00

(52) U.S. Cl. CPC G06Q 30/0206; G06Q 30/0185; G06Q 30/0623; G06Q 30/0633; G06Q 50/01; G06Q 10/06375; G06N 5/04; G06N 20/00; G06Q 10/04

(57) ABSTRACT

Automatic generation of individual item listings from a bulk listing is described. Bulk listing data associated with a bulk listing is obtained from a storage device associated with a listing system. The bulk listing data is processed to extract individual item information for individual items of the bulk listing. A plurality of individual item listings for the individual items of the bulk listing are automatically generated by populating the individual item listings with the respective individual item information extracted from the bulk listing data. In one or more implementations, relisting predictions for the individual items of the bulk listing are automatically generated and displayed in a graphical user interface.

### BACKGROUND

Digital services as implemented by computing devices are used to make a wide range of functionality available via the network. Examples of such functionality include facilitating transfer of a physical item between users. A digital service, for instance, may be configured to provide digital content in the form of an item listing that enables physical items to be procured by others. One type of item listing is a bulk listing which enables multiple physical items to be procured as part of a single transaction. In some cases, a user would like to relist the multiple physical items of the bulk listing individually. Conventional techniques used to relist multiple physical items of a bulk listing, however, have encountered numerous challenges. For example, technology used by the digital services to aid in the relisting of multiple physical items has largely been limited to tedious and time-consuming manual input of data for each individual item. Therefore, use of conventional listing systems encounter challenges due to the limited functionality for listing multiple individual items procured as part of a single transaction, which present a number of technical challenges with respect to the relisting of items. Moreover, besides the time-consuming nature of manually inputting multiple listings, the manual input of data often leads to data being input incorrectly or inaccurately, which results in bad transactional experiences, user frustration, lower user retention, inefficient transactions for the involved parties, and inefficient use of network and computational resources.

### SUMMARY

Automatic generation of individual item listings from a bulk listing is described. Bulk listing data associated with a bulk listing is obtained from a storage device associated with a listing system. The bulk listing data is processed to extract individual item information for individual items of the bulk listing. A plurality of individual item listings for the individual items of the bulk listing are automatically generated by populating the individual item listings with the respective individual item information extracted from the bulk listing data. In one or more implementations, relisting predictions for the individual items of the bulk listing are automatically generated and displayed in a graphical user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example system in which the relisting tool of FIG. 1 automatically generates individual item listings from a bulk listing in accordance with the described techniques.

FIG. 3 depicts an example of bulk listing data stored in a storage device of the service provider system in accordance with the described techniques.

FIG. 4 depicts an example of a bulk listing that is provided by a network-based commerce system.

FIG. 5 depicts an example user interface to initiate the automatic generation of individual item listings from a bulk listing.

FIG. 6 depicts an example of a user interface the displays individual item listings generated by the relisting tool of FIG. 1.

FIG. 7 depicts an example of a user interface that displays relisting predictions generated by the recommendation engine of the relisting tool.

FIG. 8 depicts an example of a user interface for sharing the investment of purchasing a bulk listing and reselling the individual items of the bulk listing.

FIG. 9 depicts an example 900 of a user interface that includes the results of relisting the individual items of a bulk listing for the shared investment.

FIG. 10 depicts an example of a visual representation of the relationship between profit and conversion time for relisting individual items of a bulk listing.

FIG. 11 depicts a procedure in an example implementation in which individual item listings are automatically generated based on bulk listing data.

FIG. 12 depicts a procedure in an example implementation in which relisting predictions for individual items of a bulk listing are generated.

FIG. 13 illustrates an example system that includes an example computing device that is representative of one or more computing systems and/or devices that may implement the various techniques described herein.

### DETAILED DESCRIPTION

Overview

Automatic generation of individual item listings from a bulk listing is described. The techniques described herein solve the problems associated with conventional listing systems by automatically generating multiple individual item listings for individual items (e.g., physical items) included in a bulk listing. As described herein, the term “bulk listing” refers to a single listing that includes a distinct quantity of individual items. A bulk listing, for example, may be implemented as digital content on a network-based commerce system that associates multiple individual items with a single purchase price such that a user can procure the multiple individual items of the bulk listing as part of a single transaction. By way of example, a bulk listing for action figures may include 20 different action figures which may be purchased “in bulk” by a user for a single purchase price associated with the bulk listing. Oftentimes, the purchase price of a bulk listing corresponds to a “wholesale” or “discounted” price such that the purchase price of the bulk listing is significantly less than the total value of the individual items if the individual items were to be purchased separately.

Accordingly, a user may initiate a single transaction to purchase a bulk listing at a discounted or wholesale price, and then “relist” the individual items of the bulk listing, e.g., separately list each of the individual items for sale. Continuing with the example above, the user, through a client device communicatively coupled to the network-based commerce system, may initiate a transaction to purchase the bulk listing that contains 20 action figures for a purchase price of $10.00, and then separately relist each individual action figure for $2.00 a piece on the network-based commerce system. In this scenario, if each of the 20 relisted action figures of the bulk listing sells for a price of $2.00, the user would realize a revenue of $40.00 and a profit of $30.00 based on the $10.00 purchase price of the bulk listing.

However, conventional listing systems require the user to manually generate each individual item listing which can be tedious and time consuming for the user, particularly for bulk listings that may include a large quantity of individual items. Using a conventional listing system, for example, the user must manually input listing information for each of the individual items, such as the item name or title, a condition of the item, a description of the item, an image of the item, and so forth. Notably, this can be tedious and time consuming endeavor, particularly in cases in which the number of items of the bulk listing may number in the hundreds or even thousands.

In addition to the tedious nature of manually relisting multiple individual items, the user of a conventional listing platform must separately determine a reasonable price for each of the individual items to ensure that the items will sell within a reasonable time. Uncertainty regarding the reasonable price and the time it will take to sell the items often makes it difficult for the user to determine whether the decision to purchase a bulk listing and relist the individual items makes sense from a financial or business perspective which thus creates a barrier to purchasing the bulk listing in the first place

In accordance with the techniques discussed herein, a relisting tool leverages bulk listing data associated with a bulk listing in order to automatically generate multiple individual item listings for the items included in the bulk listing. To do so, the relisting tool accesses bulk listing data associated with the bulk listing from a storage device of a listing system. As part of generating the original bulk listing, for example, the listing system obtains and inputs bulk listing data, e.g., from the seller of the bulk listing who inputs the bulk listing information in order to generate the listing. The bulk listing data includes item information for the individual items of the bulk listing, such as a title of each item, one or more images of each item, a condition of each item (e.g., new or used), a description of each item, and so forth. The item information contained in the bulk listing data may also include a unique identifier of each individual item, such as a universal product code (UPC). Regardless of how the bulk listing data is originally obtained, the information contained in the bulk listing data is persisted in the storage device even after the bulk listed is purchased.

The relisting tool processes the bulk listing data to extract the item listing information associated with each of the individual items of the bulk listing. The relisting tool then automatically generates a plurality of individual item listings for each of the individual items of the bulk listing by populating the individual item listings with the respective item information extracted from the bulk listing data, such as the title of each item, one or more images of each item, a condition of each item (e.g., new or used), and a description of each item. In other words, the relisting tool is able to automatically generate a plurality of different item listings—without the user having to manually enter item details—from the data of the single bulk listing that is persisted in the storage device even after a transaction to purchase the bulk listing is completed.

Along with populating the automatically generated item listings with the item information extracted from the bulk listing data, the relisting tool can automatically determine a recommended price for each of the individual items. To do so, the relisting tool can utilize the unique identifiers of the individual items of the bulk listing in order to obtain similar item data from the listing system, e.g., by comparing the UPCs of the individual items to data associated with items currently or previously listed by the listing system. The similar item data, for example, may include historical data corresponding to previous listings, as well as current or real-time data relating to similar item listings which are currently “live” or “active” on the network-based commerce system. Such similar item data may include, by way of example and not limitation, prices of similar item listings on the network-based commerce system, prices that similar items sold for on the network-based commerce system, an amount of time that a similar item was listed for on the network-based commerce system before being purchased, a number of similar item listings that are currently active on the network-based commerce system, or a number of user requests or searches for similar items on the network based commerce system.

In one or more implementations, the automatically generated individual item listings are surfaced to the user in a user interface so that the user can review the individual item listings to confirm that the listings are accurate. The user interface may also include a control which can be selected by the user to cause the individual item listing to be published to the network-based commerce system. This user interface may also include controls or functionality which enable the user to efficiently make changes to the automatically generated item listings prior to publication, such as by adjusting the price for individual items, adding additional images, modifying item descriptions, and so forth.

In some cases, the individual item listings may be automatically generated responsive to a request to relist the individual items of the bulk listing. For example, a user may purchase the bulk listing as a buyer, and then subsequently utilize the listing system as a “seller” in order to resell the individual items of the bulk listing. Alternately, rather than waiting for the user to initiate the relisting process, the relisting tool may automatically prompt the user to relist the individual items responsive to detecting that the user has purchased the bulk listing. For example, the relisting tool may initiate communication of a message (e.g., email, text message, or notification) to the user that purchased the multiple-item listing to inform the user that the individual items can be relisted for sale on the network-based commerce system.

In one or more implementations, the relisting tool can leverage the bulk listing data and the similar item data in order to generate various relisting predictions. Generally, the relisting predictions correspond to predictions or insights regarding the relisting and reselling of individual items of a bulk listing. Such relisting predictions may include, by way of example and not limitation, predicted revenue, predicted profit, predicted conversion times, and a predicted break even time. The relisting predictions may be displayed to the user in a variety of different contexts. In some cases, for example, relisting predictions can be displayed in conjunction with the bulk listing itself. In other words, the relisting predictions can be displayed within the digital content of the bulk listing. Doing so enables users to make informed decisions regarding the purchase of the bulk listing, e.g., whether purchase of the bulk listing makes sense from a business or financial perspective. Alternatively or additionally, the relisting predictions can be communicated to users that have previously purchased the bulk listing in order to inform the user's decisions during the relisting process, e.g., to optimize for revenue or conversion time. The relisting predictions can also, in some case, be provided to users in other ways, such as via electronic communications to users (e.g., via text message or email), or as digital content in the form of advertisements displayed within webpages, social network applications, and so forth.

Notably, the described techniques decrease the amount of data communicated back and forth between the client device and the service provider as compared to conventional systems. For example, rather than communicating data to the client device necessary to display a plurality of user interface screens for the user to manually input listing data and then communicating the user-entered information back to the service provider for storage, the system can instead generate the individual item listings automatically with reduced communication of data back and forth between the client and the service provider. Moreover, the efficient techniques for generating multiple item listings reduces the user frustration that often results from the tedious nature of inputting listing information for a plurality of items of a bulk listing using conventional systems. Thus, the reduction in time required to generate multiple individual item listings along with the relisting predictions which inform user decisions, leads to better transactional experiences, more efficient transactions for the involved parties, and a more efficient use of network and computational resources.

In the following discussion, an example environment is first described that may employ the techniques described herein. Example implementation details and procedures are then described which may be performed in the example environment as well as other environments. Performance of the example procedures is not limited to the example environment and the example environment is not limited to performance of the example procedures.

Example Environment

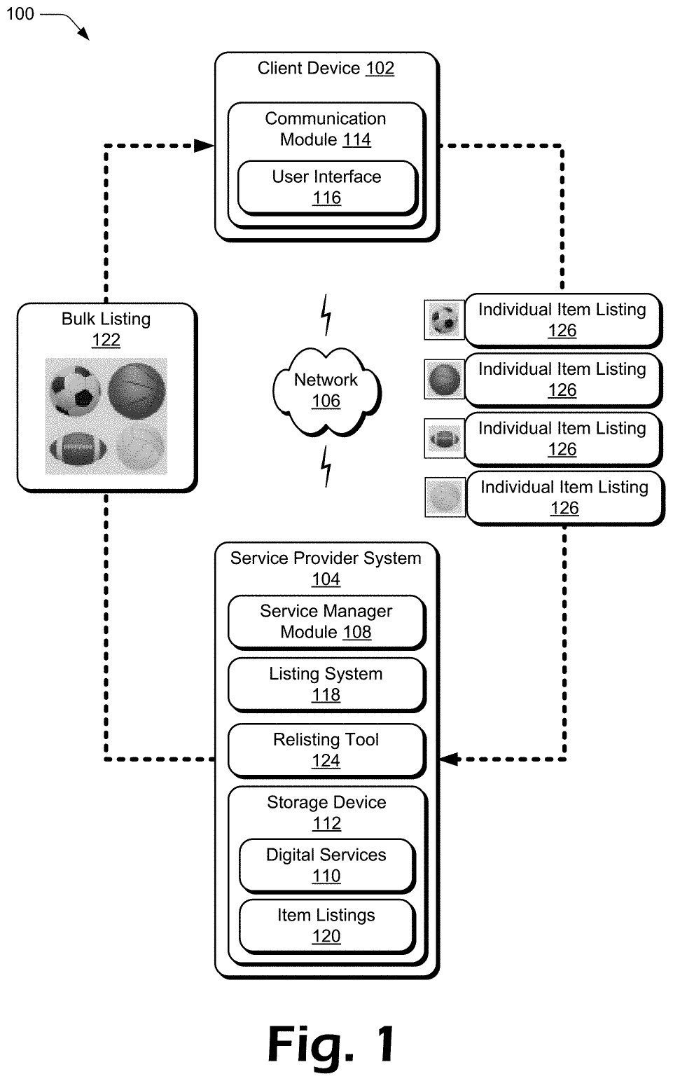

FIG. 1 is an illustration of an environment 100 in an example implementation that is operable to employ techniques described herein. The illustrated environment 100 includes a client device 102 and a service provider system 104 that are communicatively coupled, one to another via a network 106, e.g., the Internet. These entities are implemented using computing devices, which are configurable in a variety of ways.

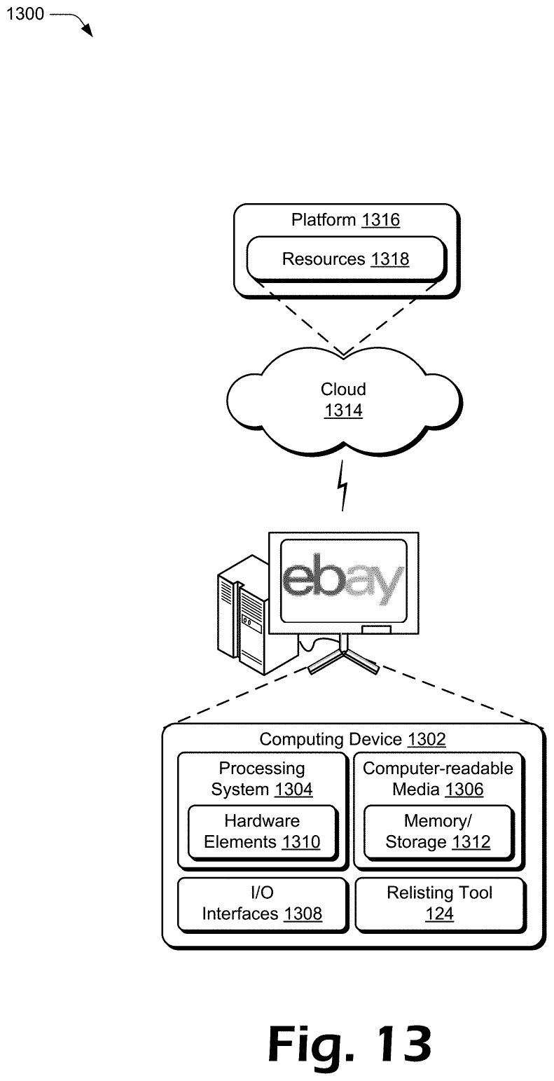

A computing device, for instance, may be configured as a desktop computer, a laptop computer, a mobile device (e.g., assuming a handheld configuration such as a tablet or mobile phone), and so forth. Thus, a computing device may range from full resource devices with substantial memory and processor resources (e.g., personal computers, game consoles) to a low-resource device with limited memory and/or processing resources (e.g., mobile devices). Additionally, although a single computing device is shown and described in some instances, a computing device may be representative of a plurality of different devices, such as multiple servers utilized by a business to perform operations “over the cloud” as described in FIG. 13.

The service provider system 104 provides services accessible via the network 106 to various client devices, such as the client device 102. The service provider system 104 includes a service manager module 108 that is configured to manage, execute, and expose digital services 110 (illustrated as stored in a storage device 112) that are made available via the network 106. Digital services 110 involve electronic delivery of data via the network 106, which may support a wide variety of functionality, such as digital streaming, content delivery, social networks, intermediary platforms, and so on. A client device 102, for instance, may include a communication module 114 that exposes a user interface 116 to access the digital services 110 via a network, such as to generate digital content, such as a webpage, social media post, offering for a physical item (e.g., for purchase), and so forth.

As part of providing digital services 110 to client devices, the service provider system 104 includes a listing system 118 which includes functionality to generate item listings 120. An item listing 120 is representative of digital content describing one or more good or services. The service provider system 104 exposes generated digital content configured as an item listing via a network-based commerce system. For instance, item listings 120 generated by the listing system 118 may be representative of digital content describing various physical goods (e.g., consumer electronics, collectables, appliances, sporting goods, books, movies, and so forth) made available for purchase via the network-based commerce system. Alternatively or additionally, item listings 120 may be representative of digital content describing various services (e.g., travel agencies, car rentals, hotel reservations, equipment rentals, real estate services, and the like) made available for purchase via the network-based commerce system. As described herein, a network-based commerce system can include any network-based service which enables digital content describing goods or services to be listed, e.g., listed for sale. Such network-based commerce systems may include online or virtual marketplaces, as well as social networks or applications which may include functionality for listing items for sale.

One particular type of item listing 120 generated by the listing system 118 is a bulk listing 122 which is representative of digital content describing multiple individual and distinct items (e.g., physical goods) made available for purchase via the network-based commerce system. A bulk listing 122, for example, may be a bulk listing for 10 different action figures, 20 different comic books, or a collection of rare coins. In this example bulk listing 122 is depicted as a bulk listing for sporting goods which includes four different types of balls, a soccer ball, a basketball, a football, and a volleyball. In this example, each item of the bulk listing 122 is different (e.g., a different type of ball), however it is to be appreciated that a bulk listing may also include multiple items of a same or similar type without departing from the spirit or the scope of the described techniques, e.g., a bulk listing for five basketballs. The data used to generate item listings 120 (e.g., a tile, condition, price, description, and images), including the data used to generate bulk listings 122, are stored in the storage device 112 of the service provider system 104.

The communication module 114 of client device 102 obtains digital content in the form of item listings from the service provider system 104 via the network 106, and outputs the item listings 120 via user interface 116. In this example, the bulk listing 122 is depicted as being communicated to the client device 102 for output via the user interface 116. The user interface 116 includes various controls which enable a user of client device 102 to select the bulk listing 122, e.g., to purchase the bulk listing for a single “purchase price”. Subsequent to purchasing the bulk listing 122, the service provider system 104 may arrange for the multiple individual items (e.g., the soccer ball, basketball, football, and volleyball) to be shipped to the user.

Oftentimes, the purchase price of a bulk listing corresponds to a “wholesale” or “discounted” price such that the purchase price of the bulk listing is significantly less than the total value of the individual items if the individual items were to be purchased separately. Accordingly, a user may purchase a bulk listing via the network-based commerce system at a discounted or wholesale price, and then “relist” the individual items of the bulk listing on the network-based commerce system, e.g., separately list each of the individual items. However, conventional systems require the user to manually generate each individual item listing which can be tedious and time consuming for the user, particularly for bulk listings that may include a large quantity of individual items.

To solve the problems encountered by conventional techniques, the listing system 118 includes a relisting tool 124 which represents functionality to automatically generate individual item listings 126 from the bulk listing 122. The relisting tool 124 may generate the multiple individual item listings responsive to a request to relist the individual items of the multiple-item listing. For example, a user of client device 102 may purchase the bulk listing 122 via the user interface 116 provided by the service provider system 104, and then subsequently utilize the user interface 116 as a “seller” in order to relist the individual items of the bulk listing 122 for purchase via the network-based commerce system. Alternately, rather than waiting for the user to initiate the relisting process, the relisting tool 124 may automatically prompt the user of client device 102 to relist the individual items responsive to detecting that the user has purchased the bulk listing 122. For example, the relisting tool 124 may initiate communication of an electronic message (e.g., email, text message, or notification) over network 106 to client device 102 or other device associated with the user that purchased the bulk listing 122 in order to inform the user that the individual items included as part of the bulk listing purchased by the user can be relisted for sale on the network-based commerce system.

In this example, the relisting tool 124 is depicted as generating multiple individual item listings 126 which each correspond to one of the physical items included as part of the bulk listing purchased by the client device 102. For example, the individual item listings 126 generated by the relisting tool 124 include separate listings for each of the soccer ball, the basketball, the football, and the volleyball. The automatically generated individual item listings 126 are shown as being communicated back from the client device 102 to the service provider system 104. The service provider system 104 obtains the automatically generated individual item listings 126, and publishes the individual item listings 126 to the network-based commerce system to enable other users to purchase the individual items.

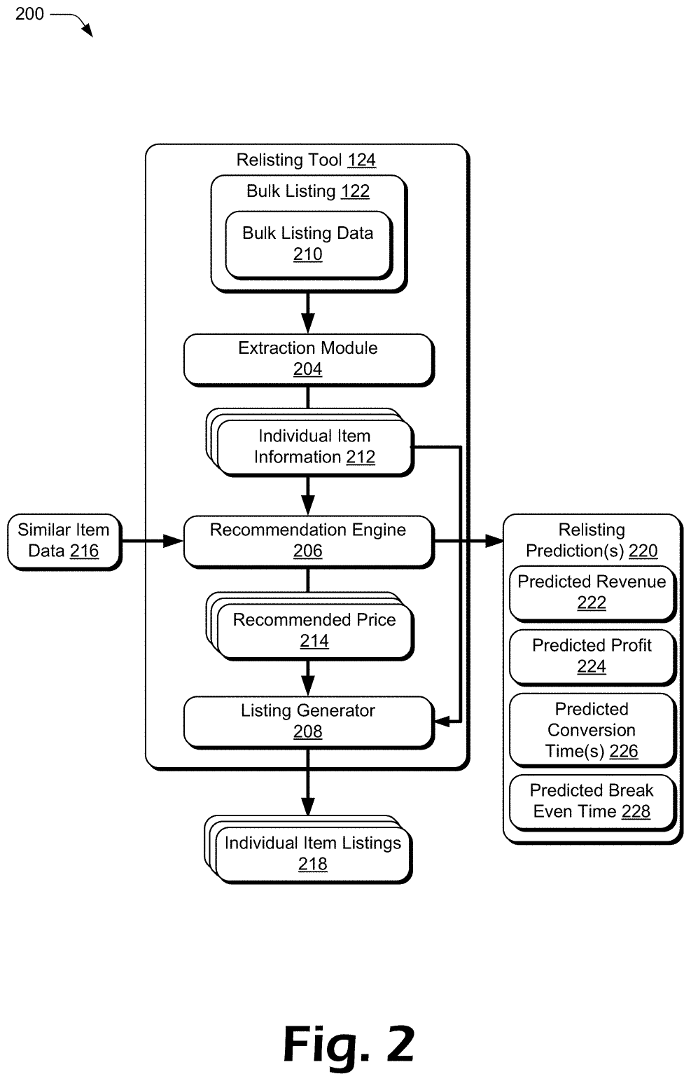

FIG. 2 depicts an example system 200 in which the relisting tool 124 of FIG. 1 automatically generates individual item listings from a bulk listing in accordance with the described techniques. In the illustrated example 200, the relisting tool 124 includes an extraction module 204, a recommendation engine 206, and a listing generator 208. Although depicted with these three modules, in implementation the relisting tool 124 may include more, fewer, or different modules to automatically generate individual item listings from a bulk listing without departing from the spirit or scope of the techniques described herein.

In the illustrated example 200, the extraction module 204 of the relisting tool 124 obtains bulk listing data associated with a bulk listing 122. The bulk listing 122 and associated data may be obtained by the extraction module 204, for example, responsive to a request by the user to relist individual items of the bulk listing, or responsive to the user purchasing the bulk listing 122. The extraction module 204 may obtain the bulk listing data 210 from the storage device 112 of the service provider system 104. For example, as part of listing the bulk listing 122 on the listing platform prior to the purchase by the user, the service provider system 104 obtains the bulk listing data 210 from the seller of the bulk listing. The service provider system 104 maintains this data in the storage device 112, even after the bulk listing 122 has been purchased by the user.

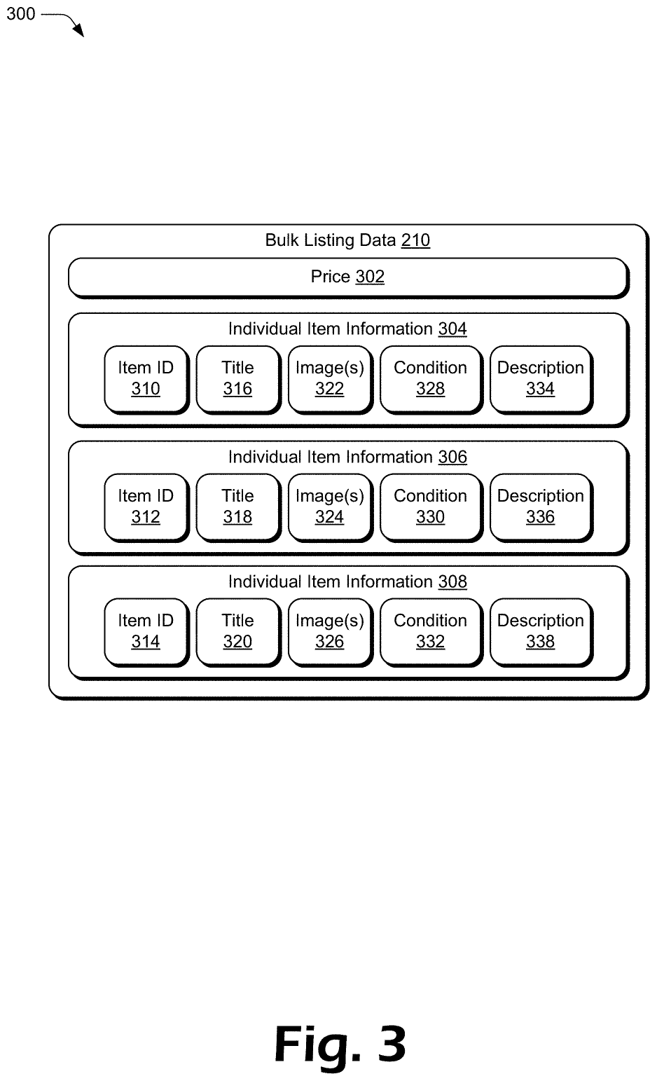

Generally, the bulk listing data 210 includes information relating to each of the individual items included as part of the bulk listing 122. For example, the bulk listing data may be implemented as a manifest file that contains information relating to the individual items of the bulk listing. As an example of bulk listing data, consider FIG. 3 which depicts an example 300 of bulk listing data 210 stored in a storage device 112 of the service provider system 104 in accordance with the described techniques. The storage device 112 may be a structured database which stores the bulk listing data utilizing various data fields. These data fields of the bulk listing data may include a price 302 of the bulk listing 122, which corresponds to the price that the bulk listing 122 was listed for by the service provider system 124 and/or the price that that the bulk listing 122 was ultimately purchased for by the user of client device 102. In some cases, the originally listed price and the price of purchase may be the same, but in other cases these prices may differ (e.g., in cases where the original listed price is more or less than the price at which the item is ultimately purchased).

In addition to the price 302, the data fields of the bulk listing data 210 may include individual item information 304, 306, and 308 for each of the individual items included as part of the bulk listing 122. It is to be appreciated that the number of instances of individual item information contained in the bulk listing data 210 for a bulk listing 122 may correspond to the number of individual items listed as part of the bulk listing. In this example, the individual item information 304, 306, and 308 includes respective item identifiers 310, 312, and 314, item titles 316, 318, and 320, item images 322, 324, and 326, item conditions 328, 330, and 332, and item descriptions 334, 336, and 338.

Generally, the item identifiers 310, 312, and 314 correspond to information that may uniquely identify the individual item included as part of the bulk listing. In one or more implementations, the item identifiers correspond to a universal product code (UPC) of the individual items. A UPC is a barcode that is uniquely assigned to various items. For example, the UPC may be printed on retail product packaging that can be scanned in order to identify the product. Generally, the UPC includes a series of unique black bars as part of the bar code along with a unique 12-digit number beneath the barcode. Notably the item identifiers may be implemented as unique identifiers other than a UPC without departing from the spirit or scope of the described techniques.

The item titles 316, 318, and 320 correspond to a descriptive title or name of the respective individual items of the bulk listing 122. The item images 322, 324, and 326 correspond to images of the respective individual items of the bulk listing 122. In some cases, the bulk listing 122 may include multiple images for some of the individual items included in the bulk listing 122. The item condition 328, 330, and 332 identifies the condition of the individual items of the bulk listing. Examples of a condition of an item include “new”, “used”, “refurbished”, and so forth. In some cases, the bulk listing may include a single data field that identifies the condition for all of the individual items, whereas in other cases the conditions may be different for different ones of the individual items. Finally, the item descriptions 334, 336, and 338 correspond to a textual description that further describes each of the individual items. Notably, the bulk listing data 210 depicted in FIG. 3 is just an example of the types of item information that can be contained in the data fields of the bulk listing data. The bulk listing data 210 can include different types of item information without departing from the spirit or scope of the described techniques.

Returning now to FIG. 2, the extraction module 204 processes the bulk listing data 210 to extract individual item information 212 for the individual items from the bulk listing data 210 of the bulk listing 122. The individual item information, for example, corresponds to the individual item information depicted in FIG. 3, such as an item identifier, title, image of the item, condition of the item, description of the item, and so forth. The extraction module 204 may extract individual item information 212 for each of the individual items included as part of the bulk listing 122. In other words, if the bulk listing 122 includes 10 individual items, then the extraction module 204 may extract distinct item information 212 for each of the 10 individual items.

The recommendation engine 206 obtains the individual item information 212, and generates a recommended price 214 for each of the individual items of the bulk listing 122. To do so, the recommendation engine 206 may leverage similar item data 216 obtained from the service provider system 104. Generally, the similar item data 216 may include data relating to similar items as the individual items of the bulk listing 122 which were listed by the listing system 118. The similar item data 216 obtained for a brand x football, for example, may include data for the same brand x football listed on the network-based commerce system. In some cases, however, such similar item data 216 may also include data for other brands of footballs listed by the network-based commerce system.

The similar item data 216 may include both historical data corresponding to previous item listings, as well as current or real-time data relating to similar item listings which are currently “live” or “active” on the network-based commerce system. The similar item data 216 may include, for example, prices of similar item listings on the network-based commerce system, prices that similar items sold for on the network-based commerce system, an amount of time that a similar item was listed for on the network-based commerce system before being purchased, a number of similar item listings that are currently active on the network-based commerce system, a number of user requests or searches for similar items on the network based commerce system, to name just a few.

The recommendation engine 206 generates the recommended price 214 for each of the individual items by applying one or more models to the similar item data 216. The models utilized by the recommendation engine 206 may include various rules which generate the recommended prices 214 based on different factors. For example, in some cases, the recommended price 214 is computed based on the prices at which similar items sold for on the network-based commerce system, e.g., an average sale price, a mean sale price, a recent sale price, and so forth. Alternatively or additionally, the models of the recommendation engine 206 may take into account the amount of time that the similar items were listed before being purchased when generating the recommended price. For example, lower prices may lead to quicker sales, whereas higher prices may lead to a longer conversion time. Thus, the recommended price may be determined based on whether the item should be sold quickly or for the highest price. In some cases, this may be based on user preferences input to the recommendation engine, such as a user preference to maximize revenue or a user preference to maximize conversion time. The recommendation engine 206 may also factor in supply and demand (or lack thereof) when generating the recommended price 214. For example, an item that is currently attracting many views or searches on the network-based commerce system may be characterized as a “hot” item due to the high demand, and thus the recommended price 214 may be adjusted higher. It is to be appreciated that the recommended price 214 may be determined in a variety of different ways without departing from the spirit or scope of the described techniques.

The listing generator 208 obtains the individual item information 212 and the recommended prices 214 for the individual items of the bulk listing 122, and then generates individual item listings 218. To generate the individual item listings 218 the listing generator 208 populates data fields for each of the individual item listings 218 with the respective individual item information 212 extracted from the bulk listing data. The listing generator 208 may also populate a price field of the individual item listings 218 with the respective recommended price 214 generated by the recommendation engine 206.

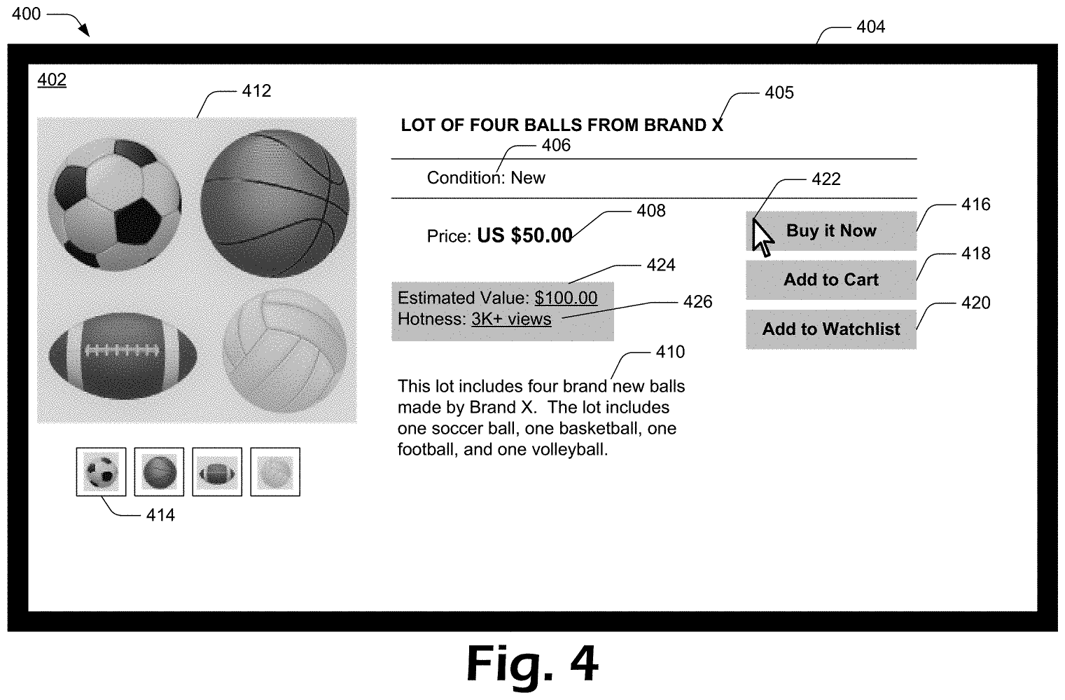

As an example of generating individual item listings, consider the following discussion of FIGS. 4-6. FIG. 4 depicts an example 400 of a bulk listing that is provided by a network-based commerce system. The illustrated example 400 includes a bulk listing 402 displayed via a display device 404. For example, the user interface may correspond to bulk listing that is listed on a network-based commerce system and included in user interface 116 displayed on a display device of client device 102. In this example, the bulk listing 402 includes digital content in the form of an item title 405 (“Lot of Four Balls from Brand X”), a condition 406 (“New”), a price 408 (“$50.00”), and an item description 410. The bulk listing 402 also includes an image 412 of the bulk listing, which in this example corresponds to an image of all four balls shown together. The bulk listing 402 also is depicted as including thumbnail images 414 of each of the individual items included as part of the bulk listing 402. Each of the individual thumbnail images 414 may be selected in order to replace the image 412 of the bulk listing with the respective image of the selected thumbnail 414.

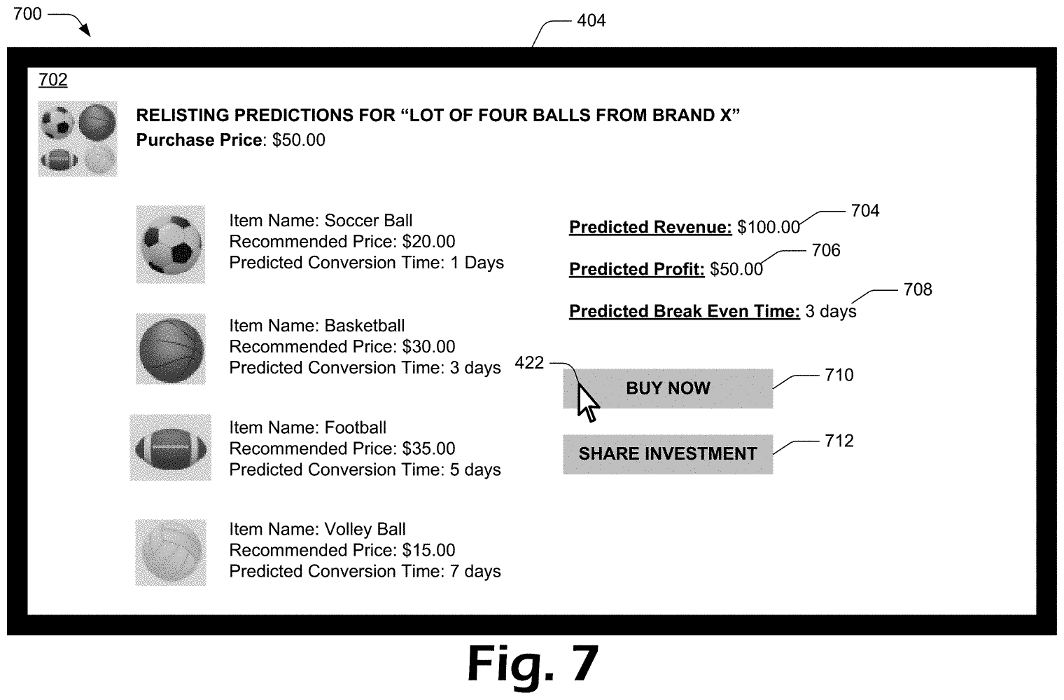

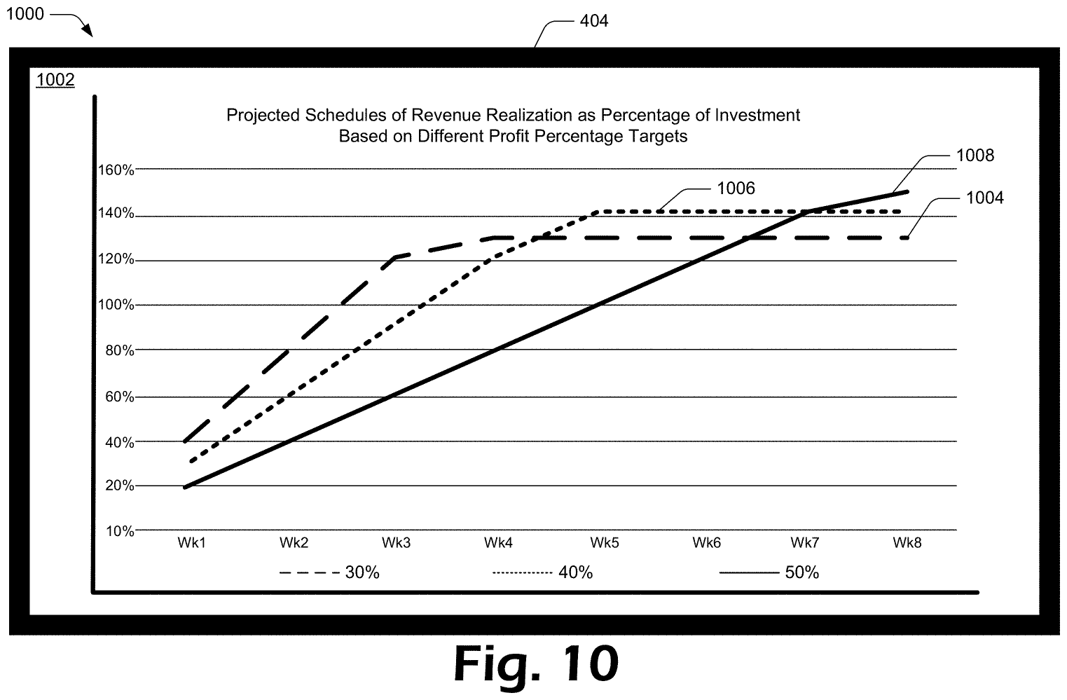

In this example, the bulk listing 402 is further depicted as including estimated value information 424 and a current demand indication 426. The estimated value information 424 can be determined by the recommendation engine 206 by computing the sum of the recommended prices determined for each of the individual items of the bulk listing 402. The current demand indication 426 is an indication of whether the individual items of the bulk listing 402 are currently in demand. This can be determined by the recommendation engine 206 based on the similar item data 216. For example, items that are currently attracting many views or searches on the network-based commerce system may be characterized as a “hot” item due to the high demand. In this case, the current demand indication 426 indicates the items of the bulk listing 402 have received over 3,000 views recently. The current demand can be indicated in other ways without departing from the spirit or scope of the described techniques, such as by displaying various icons representative of hot (e.g., in demand) items or cold items. Moreover, it is to be appreciated that the bulk listing, in some cases, can be displayed without the estimated value information 424 and/or the current demand indication 426. In other cases, the bulk listing 402 may surface other insights or predictions regarding the bulk listing without departing from the spirit or scope of the described techniques, such as by displaying the predicted revenue that can be realized by reselling the individual items, the predicted profit, the predicted break even time, and so forth. These various predictions and insights which can be generated by the recommendation engine 206 are discussed in more detail below with regards to FIGS. 7 and 10.

The bulk listing 402 is also depicted as including a buy it now control 416 which can be selected in order to purchase the bulk listing 402, an add to cart control 418 which can be selected in order to add the bulk listing 402 to a virtual shopping cart, and an add to watchlist control 420 which can be selected to add the bulk listing 402 to a watchlist. It is to be appreciated that other controls, information, or images may be included as part of the bulk listing 402 without departing from the spirit or scope of the described techniques. For example, in some cases, a place bid control may be included in the bulk listing 402 which enables the user to place a bid for the bulk listing 402.

The illustrated example 400 also includes a cursor 422, which represents functionality to enable a user to provide input to select elements or controls displayed in the bulk listing 402. Although the cursor 422 is illustrated, in one or more implementations there may be no displayed cursor. Additionally or alternately, the element and controls of the bulk listing 402 may be selected in other ways, such as via touch input (or other gesture input), keyboard input, stylus input, voice input, and so forth. In FIG. 4, the cursor 422 is depicted selecting the buy it now control 416. Selection of the buy it now control 416 causes the bulk listing 402 to be purchased via the network-based commerce system, and the service provider system 104 may then arrange for the multiple individual items (e.g., the soccer ball, basketball, football, and volleyball) to be shipped to the user.

As discussed throughout, oftentimes, the purchase price of a bulk listing corresponds to a “wholesale” or “discounted” price such that the purchase price of the bulk listing is significantly less than the total value of the individual items if the individual items were to be purchased separately on the listing platform. Accordingly, a user may purchase a bulk listing at a discounted or wholesale price, and then “relist” the individual items of the bulk listing on the network-based commerce system, e.g., separately list each of the individual items. However, conventional systems require the user to manually generate each individual item listing which can be tedious and time consuming for the user, particularly for bulk listings that may include a large quantity of individual items.

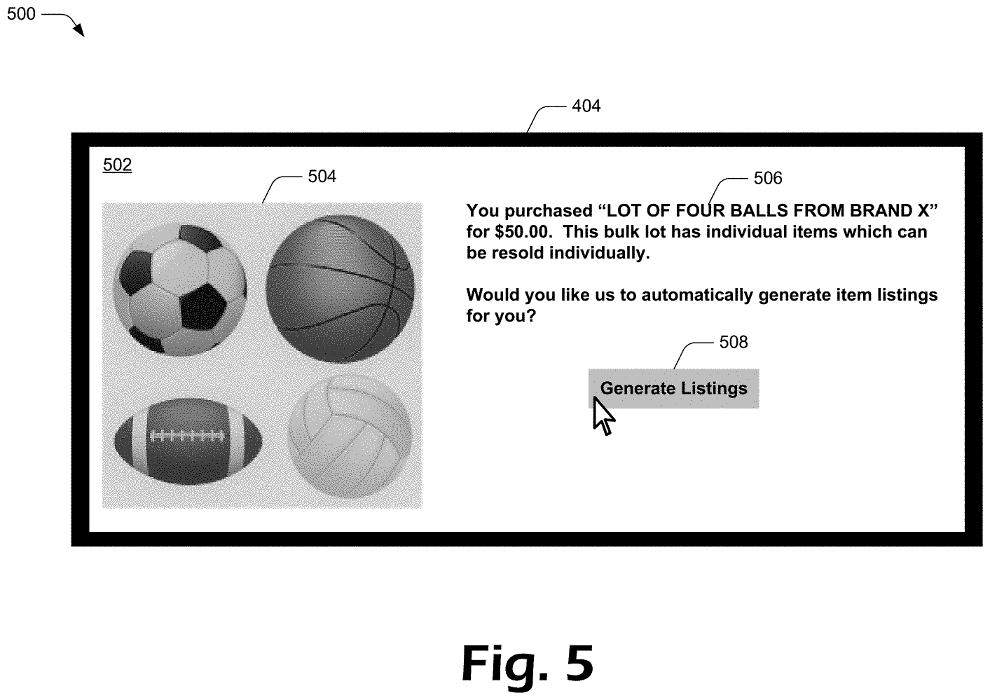

Consider now, FIG. 5, which depicts an example user interface 500 to initiate the automatic generation of individual item listings from a bulk listing. In this example, user interface 500 includes a message 502 that includes an image 504 of the bulk listing purchased by the user, and textual content 506 that informs the user that the individual items of the bulk listing may be resold individually. The textual content 506 also asks whether the user would like the system to automatically generate individual item listings from the bulk listing. Message 502 further includes a generate listings control 508, which is selectable by a user to cause the relisting tool 124 to automatically generate individual item listings 126 for the user. In this example, the cursor 422 is depicted as selecting the generate listings control 508, which causes the relisting tool 124 to generate individual item listings 126 from the bulk listing 122.

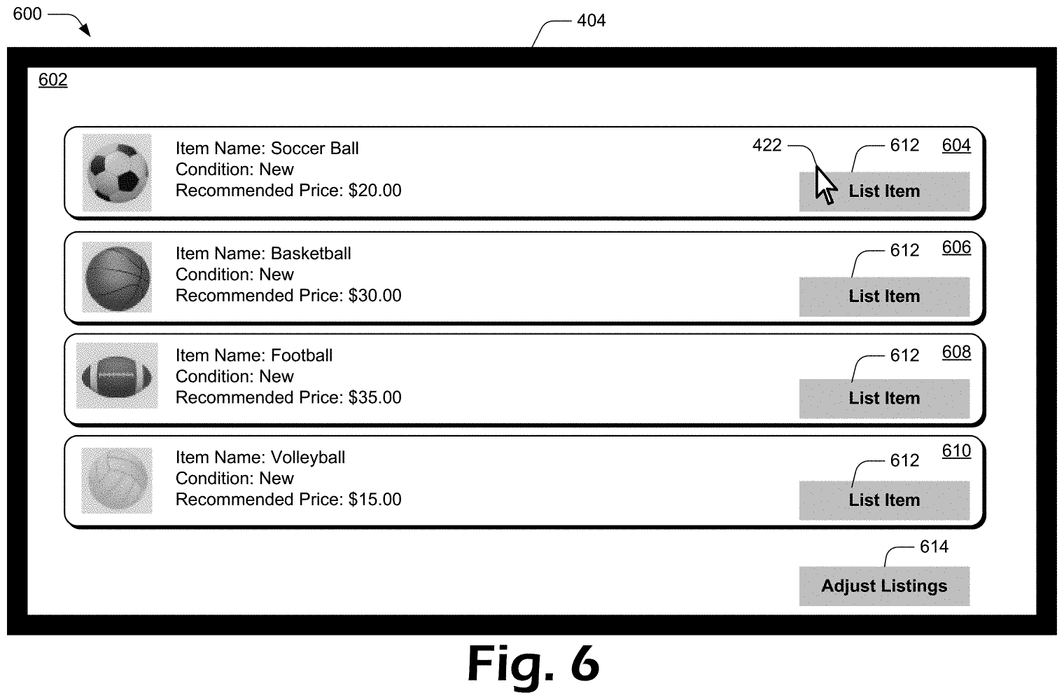

FIG. 6 depicts an example 600 of a user interface the displays individual item listings generated by the relisting tool 124 of FIG. 1. Example 600 includes a user interface 602 that can be displayed, for example, in response to the user selecting the generate listings control 508 depicted in example 500. Alternatively, the user interface 602 can be displayed when the user initiates the relisting process of the individual items via the service provider system 104. For example, the user can manually initiate the process of creating a new listing, and based on the information entered by the user, the relisting tool 124 can detect that the user has previously purchased the bulk listing that contains one of the items that the user is trying to relist. Responsive to this detection, the relisting tool 124 can then ask the user if the user would like the system to automatically generate the individually listings (e.g., similar to the message shown in FIG. 5) and then automatically generate and display the individual item listings in user interface 602.

User interface 602 is depicted as including individual item listings 604, 606, 608, and 610. Each of the individual item listings 604-610 correspond to an item listing that is automatically generated by the relisting tool 124 based on the bulk listing 122. In this example, individual item listing 604 corresponds to a listing for the soccer ball included in the bulk listing 402 depicted in example 400, individual item listing 606 corresponds to a listing for the basketball included in the bulk listing 402 depicted in example 400, individual item listing 608 corresponds to a listing for the football included in the bulk listing 402 depicted in example 400, and individual item listing 610 corresponds to a listing for the volleyball included in the bulk listing 402 depicted in example 400. Each of the individual item listings 604-610 include item information extracted from the bulk listing data of item listing 604, such as a title, an image, and a condition. It is to be appreciated that other item information that is not pictured in FIG. 6 may also be included in the preview of the item listings without departing from the spirt or scope of the described techniques, such as by including the item description for each of the individual item listings. As another example, in some cases recommendations regarding the when to list the individual items may be provided along with the individual item listings. For example, the recommendation engine 206 can determine that a certain item is currently in high demand, and thus should be listed for sale soon, or alternatively that a certain item will be in higher demand at a later date and thus should be listed at a later time. The recommendation engine 206 may determine, for example, that an item related to Halloween should not be sold in July, but instead should be listed in October.

Each of the individual item listings 604-610 also include a recommended price generated by the recommendation engine 206 of the relisting tool 124, as discussed above with regards to FIG. 2. For example, the recommendation engine 206 has generated recommended prices of $20.00 for the basketball, $30.00 for the basketball, $35.00 for the football, and $15.00 for the volleyball. Notably, if each of the individual items were to sell for the recommended prices, the value of the individual items would total $100.00. Based on the $50.00 purchase price of the bulk listing 402, the user would then realize a profit of $50.00 by relisting the individual items at the recommended prices.

User interface 602 further includes a list item control 612, which is depicted as being included proximate each of the individual item listings 604-610. The list item control 612 can be selected in order to cause the respective individual item listing to be listed by the listing system 118, e.g., listed for sale on the network-based commerce system. In example 600, cursor 422 is depicted as selecting the list item control 612 associated with the individual item listing 604 which causes the individual item listing 604 for the soccer ball to be listed. The user can also select other ones of the generated individual item listings in order to cause the respective item listings to be listed. Alternately, rather than having separate item listing controls proximate each of the item listings, the user interface 602 may include a single list item control which is selectable to cause all of the item listings to be listed in bulk. In one or more implementations, the item listings can be automatically generated and listed by the listing system without first displaying the item listings to the user. It is to be appreciated, therefore, that the relisting tool 124 enables the user to efficiently and quickly relist individual items of a bulk listing without the tedious and time consuming manual entry of listing information required by conventional systems.

Displaying the automatically generated individual item listings 604-610 in the user interface 602 enables the user to review the item listings before the item listings are listed by the listing system 118. In some cases, for example, the information for one or more of the individual item listings may be incomplete, incorrect, or the user may want to add additional information to the listing, such as additional images or a more robust description. Moreover, in some cases the user may wish to modify the recommended prices of one or more of the individual item listings, such as by increasing the recommended price in order to increase profit, or by decreasing one or more of the recommended prices in order to decrease conversion time. To enable the user to make changes to one or more of the automatically generated item listings, the user interface 602 is further depicted as including an adjust listings control 614 which is selectable to adjust the information of one or more of the automatically generated individual item listings. Selection of the adjust listings control 614, for example, may cause the relisting tool 124 to display an additional user interface (not pictured) which enables the user to modify or add information to the individual item listings, such as by adjusting the price, modifying the title, adding additional images, and so forth.

Returning to FIG. 2, in addition to generating the recommended prices 214 for individual items of a bulk listing, the recommendation engine 206 is further configured to generate various relisting predictions 220 based on the information extracted from the bulk listing data 210 and the similar item data 216. Generally, the relisting predictions 220 correspond to predictions or insights regarding the relisting and reselling of individual items of a bulk listing. Such relisting predictions 220 may include, by way of example and not limitation, a predicted revenue 222, a predicted profit 224, predicted conversion times 226, and a predicted break even time 228. For example, based on the similar item data 216, the recommendation engine 206 can generate the recommended prices 214 and then determine the predicted revenue 222 corresponding to the total revenue realized if each of the individual items of the bulk listing are sold at the recommended price. Additionally, the recommendation engine 206 can determine the predicted profit 224 for the bulk listing by subtracting the purchase price of the bulk listing from the predicted revenue 222 that can be achieved by reselling the individual items of the bulk listing. Additionally, based on the similar item data 216, the recommendation engine 206 can determine the predicted conversion times 226 for each of the individual items corresponding to the amount of time it will take to sell the individual items of the bulk listing at the respective recommended prices 214. Additionally, based on the predicted conversion times 226 and the recommended prices 214, the recommendation engine 206 can determine the predicted break even time 228 for the bulk listing. In other words, the predicted break even time 228 corresponds to the predicted amount of time that it will take for the user to recoup the cost of the purchase price of the bulk listing by selling a sum of the individual items at the recommended prices 214 for each item.

In the context of generating relisting predictions, consider FIG. 7 which depicts an example 700 of a user interface that displays relisting predictions generated by the recommendation engine 206 of the relisting tool 124. Example 700 includes user interface 702, which provides various relisting predictions for the individual items of the bulk listing for the “Lot of Four Balls from Brand X”. In this example, user interface 702 displays, for each of the individual items of the bulk listing, the recommended prices 214 and predicted conversions times 226 generated by the recommendation engine 206. As discussed throughout, the recommendation engine 206 can generate these predictions based on the bulk listing data 210 and the similar item data 216.

The user interface 702 further includes a predicted revenue 704, a predicted profit 706, and a predicted break even time 708. In this example, the predicted revenue 704 is computed as $100.00 by the recommendation engine 206. The recommendation engine 206 generates this prediction by taking the sum of the recommended prices for each of the individual items of the bulk listing, which in this case includes recommended prices of $20.00, $30,00, $35.00, and $15.00. The recommendation engine 206 then generates the predicted profit 706 of $50.00 by subtracting the purchase price of the bulk listing ($50.00) from the predicted revenue ($100.00). Finally, the recommendation engine 206 generates the predicted break even time 708 as three days. This is determined because both the soccer ball (valued at $20.00) and the basketball (valued at $30.00) are predicted to sell within 3 days. The total value of these two items is $50.00, which corresponds to the purchase price of the bulk listing. Thus, the recommendation engine 206 predicts that the user will recoup their investment in purchasing the bulk listing within three days.

The user interface 702 is further depicted as including a buy now control 710 which is selectable to initiate the purchase of the bulk listing. In some cases, selection of the buy now control 710 may also cause the relisting tool 124 to automatically generate the individual item listings. In other words, rather than requiring the user to subsequently initiate the relisting process, the system enables the user to both purchase the bulk listing and automatically generate individual listings for the items of the bulk listing by selecting the buy now control 710. Notably, the user interface 702 can include various other types of relisting predictions without departing from the spirit or scope of the described techniques. In one or more implementations, for example, the user interface 702 may surface similar item listings (e.g., that are currently active) in order to inform the user of the pricing for similar items that are currently listed.

The user interface 702 may be displayed to the user in a variety of different contexts. In some cases, for example, the user interface 702 containing the relisting predictions can be displayed in conjunction with the bulk listing itself. For example, various ones of the relisting predictions 220 can be displayed within the bulk listing, such as the bulk listing 402 depicted in FIG. 4. Displaying the relisting predictions 220 within the original bulk listings enables users to make informed decisions regarding the purchase of the bulk listing. Alternatively or additionally, the user interface 702 can be displayed to the user responsive to user selection of a control displayed within the bulk listing. For example, a control may be displayed within the bulk listing 402 depicted in FIG. 4 which is selectable to view the various relisting predictions 220. In this way, users that are interested in purchasing the bulk listing with the intent to resell the individual items can easily select a control to view more information and predictions regarding the relisting process. Alternatively or additionally, the user interface 702 can be implemented within an electronic message (e.g., a text message, email, or notification) that is communicated to users. Such messages, for example, can be communicated to users that have previously resold individual items of a bulk listing and/or expressed interest in this process. Alternatively or additionally, the user interface 702 can be implemented as digital content in the form of advertisements displayed within webpages, social network applications, and so forth. For example, the relisting predictions 220 can be presented as an advertisement to show users that a bulk listing is available for purchase that can be relisted for profit. There are various other ways in which the relisting predictions can be surfaced to users without departing from the spirit or scope of the described techniques.

User interface 702 is further depicted as including a share investment control 712 which is selectable to share the purchase price of the bulk listing with other users, such that the shared investors can also share in the revenue and profit generated by relisting the individual items of the bulk listings. This functionality may be particularly useful in circumstances where a bulk listing may include hundreds or thousands of different items offered at wholesale prices. Such bulk listings, even if discounted steeply, may have a high purchase price due to the large quantity of items. Thus, a user may determine that purchasing and re-selling the bulk listing is a good business decision, but the high purchase prices of the bulk listing may be a barrier that prevents the user from making the purchase. On the other hand, even in cases where a user may have the funds to purchase a bulk listing, the user may have limited time to oversee the re-listing process and thus may wish to share the purchase and management of the relisting process with other users. To solve these problems, in one or more implementations the system enables the users to share the investment of purchasing and reselling bulk listings with other users.

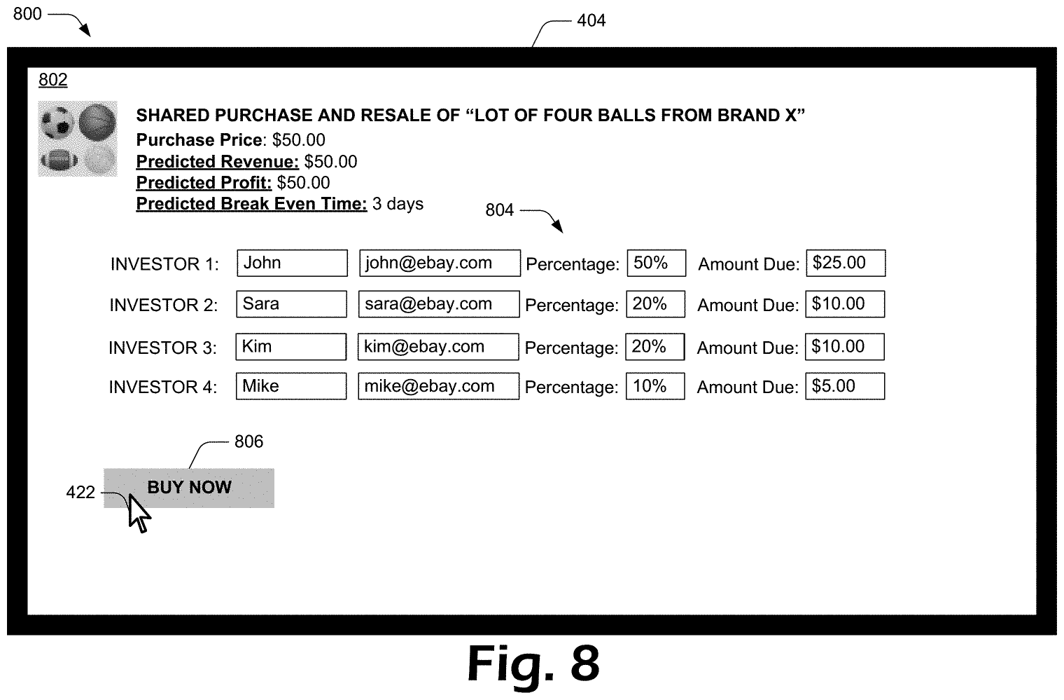

In the context of shared investment of bulk listings, consider FIG. 8 which depicts an example 800 of a user interface for sharing the investment of purchasing a bulk listing and reselling the individual items of the bulk listing. In example 800, a user interface 802 includes data entry fields 804 for the user to enter investor information corresponding to users that will share the investment of purchasing a bulk listing and relisting the individual items. In this example, the user has input the names and emails of four different investors, as well as the investment percentage of each user. Based on the purchase price and the respective investment percentages, the system computes an amount due for each of the investors in order to purchase the bulk listing. In this example, John pays $25.00 (representing 50% of the purchase price), Sara pays $10.00 (representing 20% of the purchase price), Kim pays $10.00 (representing 20% of the purchase price), and Mike pays $5.00 (representing 10% of the purchase price).

The user interface 802 is also depicted as including a buy now control 806 which can be selected to initiate the shared investment purchase. For example, responsive to selection of the buy now control 806 the bulk listing is purchased using the funds determined for the shared investment. In some cases, selection of the buy now control 806 may also initiate the relisting tool 124 to automatically generate the individual item listings. In this way, a group of users can quickly and easily purchase a bulk listing and relist the individual items as a shared investment.

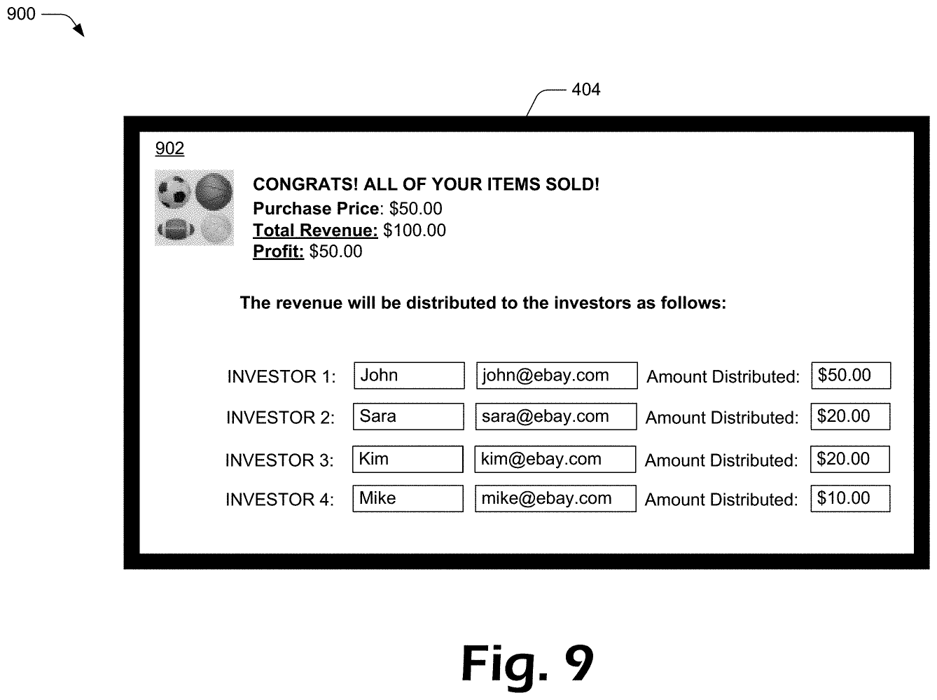

Continuing with this example, FIG. 9 depicts an example 900 of a user interface that includes the results of relisting the individual items of a bulk listing for the shared investment. In this example, a user interface 902 indicates that all of the individual items that were relisted sold for a total revenue of $100.00 which corresponds to a profit of $50.00. The user interface 902 also indicates the distribution amounts for each of the investors which are determined based on the original investment percentages. In this example, the distribution amounts are $50.00 to John, $20.00 to Sara, $20.00 to Kim, and $10.00 to Mike. Thus, in this example, John realizes a profit of $25.00, Sara and Kim each realize a profit of $10.00, and Mike realizes a profit of $5.00.

While examples 800 and 900 depict a shared investment for an example bulk listing containing a relatively low number of individual items, it is to be appreciated that the shared investment functionality can also be utilized to share investments for bulk purchases in cases where the number of individual items number in the hundred or even thousands. In these cases particularly, the relisting tool 124 greatly reduces the complexity of relisting hundreds or even thousands of items, while also managing the collection and distribution of funds to the investors.

There are a variety of factors that users consider when relisting individual items of a bulk listing. In some cases, users may wish to maximize the total revenue by listing the individual items for high prices, even if doing so may increase the conversion time. Other users, however, may be interested in reselling the individual items quickly in order to recoup their investment and realize a profit as soon as possible. As discussed throughout, the recommendation engine 206 may take these various factors and preferences into account when determining the recommended prices for relisting an item of a bulk listing.

In one or more implementations, the recommendation engine 206 of the relisting tool 124 is further implemented to generate a visual representation that depicts the relationship between profit and conversion time such that the user can understand how an increased price point of an individual item may impact the time until sales conversion. By way of example, consider FIG. 10 which depicts an example 1000 of a visual representation of the relationship between profit and conversion time for relisting individual items of a bulk listing. In example 1000, the relisting tool provides a visual representation in the form of a graph 1002 which depicts projected schedules of revenue realization as a percentage of investment based on different profit targets. The graph 1002 allows the user to optimize for conversion velocity or alternatively for revenue generation.

The graph 1002 includes the predicted revenue as a percentage of investment along the Y-axis and the predicted conversion time in terms of weeks along the X-axis. The graph 1002 also includes lines 1004, 1006, and 1008 representing different profit targets. In this example, line 1004 represents a profit target of 30% (or 130% of revenue as a percentage of purchase price) and indicates that the profit target of 30% has a predicted conversion time of approximately 4 weeks. Similarly, line 1006 represents a profit target of 40% (or 140% of revenue as a percentage of purchase price) and indicates that the profit target of 40% has a predicted conversion time of approximately 5 weeks. Similarly, line 1008 represents a profit target of 50% (or 150% of revenue as a percentage of purchase price) and indicates that the profit target of 50% has a predicted conversion time of approximately 8 weeks.

Thus the graph 1002 informs the user that pricing the items lower (e.g., to achieve a 30% profit goal) will allow faster sales and revenue realization (e.g., 3 weeks) but results in a lower final profit, whereas pricing items higher (e.g., to achieve a 50% profit goal) will result in higher final profit but at the cost of slower sales and revenue realization (e.g., 8 weeks). Thus, from this graph the user can easily understand that the different values for target profit will affect the projected schedule of revenue realization.

In one or more implementations, the user may be able to select a desired profit target (e.g., 40%) in order to automatically adjust the recommended prices generated by the recommendation engine and included in the individual item listings. In other words, responsive to user input to select a certain profit target, the recommendation engine 206 of the relisting tool 124 automatically adjusts the recommended prices included in each of the individual item listings. In this way, the graph 1002 can inform the user's choices in pricing the individual items in order to achieve both profit and conversion time goals. In one or more implementations, the relisting tool 124 may also allow the user to set a desired break-even time, and then generate the recommended prices for the individual items to achieve this goal. While profit goals of 30%, 40%, and 50% are depicted in this example, it is to be understood that the relisting tool 124 may select other profit targets or allow the user to select the profit targets, e.g., the user may be able to change the profit targets to 20%, 40%, 60%, and 80%. Moreover, while a graph is used to depict the relationship between profit and conversion time in this example, it is to be appreciated that the relisting tool may generate a variety of different types of visual representations showing the relationship between profit and conversion time without departing from the spirit or scope of the describe techniques. For example, in one or more implementations, a probability of conversion of an individual item can also be included with the graph 1002.

Example Procedures

This section describes example procedures for automatic generation of individual item listings from a bulk listing. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks. In at least some implementations the procedures are performed by a listing system, such as listing system 118 which makes use of a relisting tool 124.

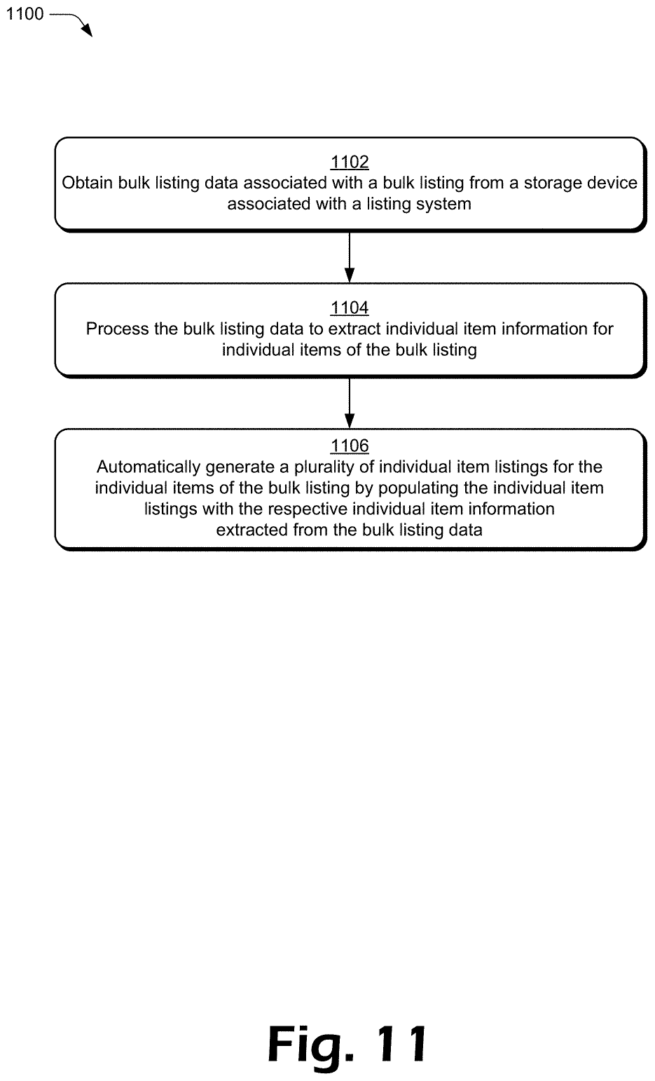

FIG. 11 depicts a procedure 1100 in an example implementation in which individual item listings are automatically generated based on bulk listing data.

Bulk listing data associated with a bulk listing is obtained from a storage device associated with a listing system (block 1102). By way of example, the extraction module 204 of the relisting tool 124 obtains bulk listing data associated with a bulk listing 122. The bulk listing 122 and associated data may be obtained by the extraction module 204, for example, responsive to a request by the user to relist individual items of the bulk listing, or responsive to the user purchasing the bulk listing 122. The extraction module 204 may obtain the bulk listing data 210 from the storage device 112 of the service provider system 104. For example, as part of listing the bulk listing 122 on the listing platform prior to the purchase by the user, the service provider system 104 obtains the bulk listing data 210 from the seller of the bulk listing. The service provider system 104 maintains this data in the storage device 112, even after the bulk listing 122 has been purchased by the user. Generally, the bulk listing data 210 includes information relating to each of the individual items included as part of the bulk listing 122. For example, the bulk listing data may be implemented as a manifest file that contains information relating to the individual items of the bulk listing.

The bulk listing data is processed to extract individual item information for individual items of the bulk listing (block 1104). By way of example, the extraction module 204 processes the bulk listing data 210 to extract individual item information 212 for the individual items from the bulk listing data 210 of the bulk listing 122. The individual item information, for example, corresponds to the individual item information depicted in FIG. 3, such as an item identifier, title, image of the item, condition of the item, description of the item, and so forth. The extraction module 204 may extract individual item information 212 for each of the individual items included as part of the bulk listing 122.

In addition to extracting the individual item information, the recommendation engine 206 may generate a recommended price 214 for each of the individual items by applying one or more algorithms or models to the similar item data 216. The algorithms or models utilized by the recommendation engine 206 may include various rules which generate the recommended prices 214 based on different factors, as discussed throughout

A plurality of individual item listings for the individual items of the bulk listing are automatically generated by populating the individual item listings with the respective individual item information extracted from the bulk listing data (block 1106). By way of example, the listing generator 208 obtains the individual item information 212 for the individual items of the bulk listing 122, and then generates individual item listings 218. To generate the individual item listings 218 the listing generator 208 populates data fields for each of the individual item listings 218 with the respective individual item information 212 extracted from the bulk listing data. As part of this, the listing generator 208 may also populate a price field of the individual item listings 218 with the respective recommended price 214 generated by the recommendation engine 206.

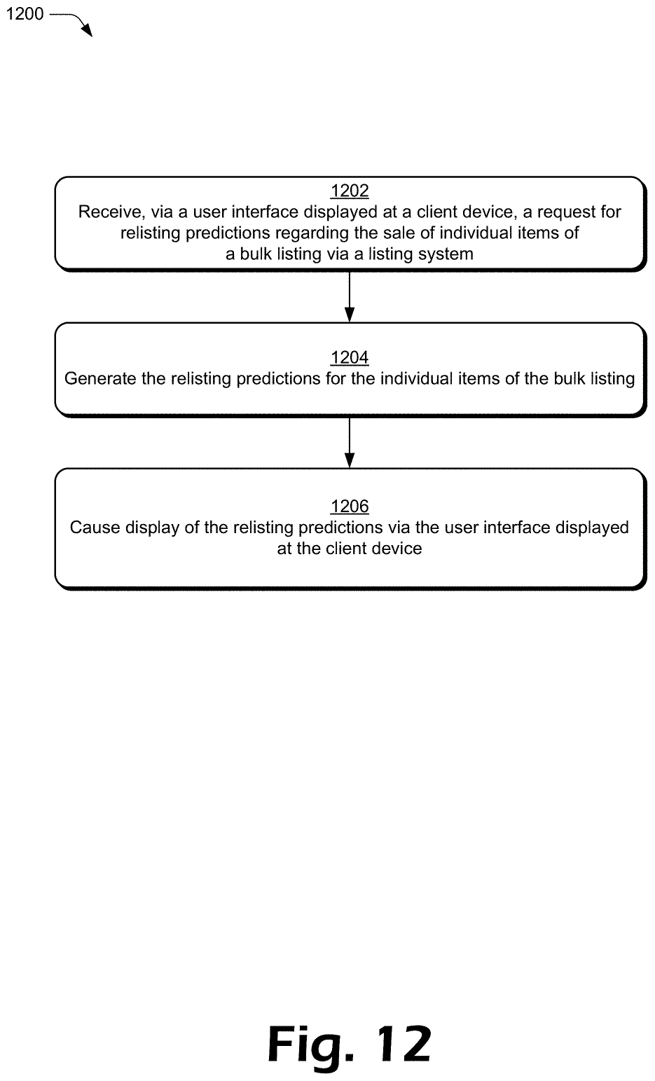

FIG. 12 depicts a procedure 1200 in an example implementation in which relisting predictions for individual items of a bulk listing are generated.

A request is received, via a user interface displayed at a client device, for relisting predictions regarding the sale of individual items of a bulk listing via a listing system (block 1202). By way of example, the recommendation engine 206 receives a request via a user interface 116 displayed at a client device 102, for relisting predictions 220 regarding the sale of individual items of a bulk listing 122 via a listing system 118.

The relisting predictions for the individual items of the bulk listing are generated (block 1204), and the relisting predictions are displayed via the user interface (block 1206). By way of example, the recommendation engine 206 generates various relisting predictions 220 based on the information extracted from the bulk listing data 210 and the similar item data 216. Generally, the relisting predictions 220 correspond to predictions or insights regarding the relisting and reselling of individual items of a bulk listing. Such relisting predictions 220 may include, by way of example and not limitation, a predicted revenue 222, a predicted profit 224, predicted conversion times 226, and a predicted break even time 228. For example, based on the similar item data 216, the recommendation engine 206 can generate the recommended prices 214 and then determine the predicted revenue 222 corresponding to the total revenue realized if each of the individual items of the bulk listing are sold at the recommended price. Additionally, the recommendation engine 206 can determine the predicted profit 224 for the bulk listing by subtracting the purchase price of the bulk listing from the predicted revenue 222 that can be achieved by reselling the individual items of the bulk listing. Additionally, based on the similar item data 216, the recommendation engine 206 can determine the predicted conversion times 226 for each of the individual items corresponding to the amount of time it will take to sell the individual items of the bulk listing at the respective recommended prices 214. Additionally, based on the predicted conversion times 226 and the recommended prices 214, the recommendation engine 206 can determine the predicted break even time 228 for the bulk listing. In other words, the predicted break even time 228 corresponds to the predicted amount of time that it will take for the user to recoup the cost of the purchase price of the bulk listing by selling a sum of the individual items at the recommended prices 214 for each item.

Example System and Device

FIG. 13 illustrates an example system 1300 that includes an example computing device 1302 that is representative of one or more computing systems and/or devices that may implement the various techniques described herein. This is illustrated through inclusion of the relisting tool 124. The computing device 1302 may be, for example, a server of a service provider, a device associated with a client (e.g., a client device), an on-chip system, and/or any other suitable computing device or computing system.

The example computing device 1302 as illustrated includes a processing system 1304, one or more computer-readable media 1306, and one or more I/O interface 1308 that are communicatively coupled, one to another. Although not shown, the computing device 1302 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1304 is representative of functionality to perform one or more operations using hardware. Accordingly, the processing system 1304 is illustrated as including hardware element 1310 that may be configured as processors, functional blocks, and so forth. This may include implementation in hardware as an application specific integrated circuit or other logic device formed using one or more semiconductors. The hardware elements 1310 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1306 is illustrated as including memory/storage 1312. The memory/storage 1312 represents memory/storage capacity associated with one or more computer-readable media. The memory/storage component 1312 may include volatile media (such as random access memory (RAM)) and/or nonvolatile media (such as read only memory (ROM), Flash memory, optical disks, magnetic disks, and so forth). The memory/storage component 1312 may include fixed media (e.g., RAM, ROM, a fixed hard drive, and so on) as well as removable media (e.g., Flash memory, a removable hard drive, an optical disc, and so forth). The computer-readable media 1306 may be configured in a variety of other ways as further described below.

Input/output interface(s) 1308 are representative of functionality to allow a user to enter commands and information to computing device 1302, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1302 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1302. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1302, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1310 and computer-readable media 1306 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1310. The computing device 1302 may be configured to implement particular instructions and/or functions corresponding to the software and/or hardware modules. Accordingly, implementation of a module that is executable by the computing device 1302 as software may be achieved at least partially in hardware, e.g., through use of computer-readable storage media and/or hardware elements 1310 of the processing system 1304. The instructions and/or functions may be executable/operable by one or more articles of manufacture (for example, one or more computing devices 1302 and/or processing systems 1304) to implement techniques, modules, and examples described herein.

The techniques described herein may be supported by various configurations of the computing device 1302 and are not limited to the specific examples of the techniques described herein. This functionality may also be implemented all or in part through use of a distributed system, such as over a “cloud” 1314 via a platform 1316 as described below.

The cloud 1314 includes and/or is representative of a platform 1316 for resources 1318. The platform 1316 abstracts underlying functionality of hardware (e.g., servers) and software resources of the cloud 1314. The resources 1318 may include applications and/or data that can be utilized while computer processing is executed on servers that are remote from the computing device 1302. Resources 1318 can also include services provided over the Internet and/or through a subscriber network, such as a cellular or Wi-Fi network.

The platform 1316 may abstract resources and functions to connect the computing device 1302 with other computing devices. The platform 1316 may also serve to abstract scaling of resources to provide a corresponding level of scale to encountered demand for the resources 1318 that are implemented via the platform 1316. Accordingly, in an interconnected device embodiment, implementation of functionality described herein may be distributed throughout the system 1300. For example, the functionality may be implemented in part on the computing device 1302 as well as via the platform 1316 that abstracts the functionality of the cloud 1314.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method implemented by a computing device, the method comprising:
obtaining bulk listing data associated with a bulk listing from a storage device associated with a listing system;
processing the bulk listing data to extract individual item information for individual items of the bulk listing; and
automatically generating a plurality of individual item listings for the individual items of the bulk listing by populating the individual item listings with the respective individual item information extracted from the bulk listing data.

2. The method of claim 1, further comprising determining a recommended price for each of the plurality of individual items of the bulk listing.

3. The method of claim 2, wherein the generating the plurality of individual item listings further comprises populating each of the individual item listings with the respective recommended prices and the respective individual item information extracted from the bulk listing.

4. The method of claim 2, wherein the individual item information extracted from the bulk listing data includes unique item identifiers for the individual items of the bulk listing, and wherein the determination of the recommended price is based on similar item data obtained from the listing system using the respective unique item identifiers extracted from the bulk listing data.

5. The method of claim 1, wherein the plurality of the individual item listings are populated with individual item information extracted from the bulk listing that includes a title of the respective individual item, a condition of the respective individual item, and one or more images of the respective individual item

6. The method of claim 1, further comprising causing display of the individual item listings in a user interface along with a selectable control to publish the individual item listings to the listing system.

7. The method of claim 6, further comprising publishing the individual item listings to the listing system responsive to a selection of the selectable control.

8. The method of claim 6, wherein the user interface further includes functionality to modify the individual item listings before publishing the individual item listings to the listing system.

9. The method of claim 1, wherein individual item listings are automatically generated responsive to a request received from a user that purchased the bulk listing via a single transaction with the listing system.

10. The method of claim 1, further comprising generating one or more relisting predictions for the individual items of the bulk listing, the one or more relisting predictions comprising at least one of:
a predicted revenue corresponding to a total revenue realized if each of the individual items of the bulk listings are sold at the recommended price;
a predicted profit determined based on the predicted revenue and a purchase price of the bulk listing;
predicted conversion times corresponding to an amount of time it will take to sell each of the respective individual items of the bulk listing at the respective recommended prices; and
a break even time determined based on the recommended prices and the predicted conversions times of the respective individual items of the bulk listing.

11. A method implemented by a computing device, the method comprising:
receiving, via a user interface displayed at a client device, a request for relisting predictions regarding the sale of individual items of a bulk listing via a listing system;
generating the relisting predictions for the individual items of the bulk listing; and
causing display of the relisting predictions via the user interface displayed at the client device.

12. The method of claim 11, wherein the relisting predictions displayed via the user interface include a recommended price for selling each of the respective individual items of the bulk listing via the listing system.

13. The method of claim 12, wherein the relisting predictions displayed via the user interface include a predicted revenue corresponding to a total revenue realized if each of the individual items of the bulk listings are sold at the recommended price.

14. The method of claim 13, wherein the relisting predictions displayed via the user interface include a predicted profit determined based on the predicted revenue and a purchase price of the bulk listing.

15. The method of claim 14, wherein the relisting predictions displayed via the user interface include predicted conversion times corresponding to an amount of time it will take to sell each of the respective individual items of the bulk listing at the respective recommended prices.

16. The method of claim 15, wherein the relisting predictions displayed via the user interface include a break even time determined based on the recommended prices and the predicted conversions times of the respective individual items of the bulk listing.

17. The method of claim 11, wherein the relisting predictions are displayed in a user interface associated with the bulk listing, the user interface further comprising a purchase price for purchasing the bulk listing and a selectable control to purchase the bulk listing for the purchase price.

18. The method of claim 11, wherein the client device is associated with a user that purchased the bulk listing via the listing system.

19. The method of claim 11, wherein the relisting predictions displayed via the user interface further includes a graph depicting the relationship between different profit targets for relisting the individual items and predicted conversion times for the different profit targets.

20. One or more computer-readable storage media comprising instructions stored thereon that, responsive to execution by one or more processors, perform operations comprising:
receiving, via a user interface, a request to generate a plurality of individual item listings corresponding to individual items of a bulk listing procured by a user in a single transaction;
responsive to the request, automatically generating the plurality of individual item listings; and
displaying, in the user interface, the plurality of automatically generated individual item listings corresponding to the individual items, the individual item listings comprising a title for each respective individual item, an image of each respective individual item, and an automatically generated recommended price for each respective individual item.
